(19) United States
(12) Patent Application Publication
(10) Pub. No.: US 2005/0099342 A1
(43) Pub. Date: May 12, 2005

(54) Device for reducing the electromagnetic wave of a mobile communication terminal

(76) Inventors: Eung-Soon Chang, Seoul (KR); Youn-Myung Kim, Seoul (KR); Chang-Ho Ra, Kyunggi-do (KR)

Correspondence Address: R Neil Sudol;Coleman Sudol Sapone, 714 Colorado Avenue, Bridgeport, CT, 06605-1601, US

(21) Appl. No.: 10/415,691

(22) PCT Filed: Feb. 12, 2001
(86) PCT No.: PCT/KR01/00202

(30) Foreign Application Priority Data
Dec. 5, 2000 (KR) 2000/73424
Dec. 12, 2000 (KR) 2000/75517

(51) Int. Cl. H01Q 1/24

(52) U.S. Cl. 343/702; 343/841

(57) ABSTRACT

The present invention provides reduction of injury to the human body by effectively reducing short-distance electromagnetic waves without any influence on long-distance electromagnetic waves which act upon a telephone communication amongst electromagnetic waves radiated from antenna of mobile communication terminals. An electromagnetic wave absorber, absorbing short-distance electromagnetic wave, is installed at the exterior of a metal rod fixed to a helical antenna, an upper portion of the electromagnetic wave absorber is formed having a big diameter, a lower portion is formed having a small diameter, and a through bore is formed at the central portion, said metal rod being inserted at through bore or is in its entirety formed as a cylinder, and formation of a through bore at the central portion leads said helical antenna to be inserted at through bore or leads electromagnetic wave absorber to be inserted and integrally formed thereon.

### BRIEF DESCRIPTION OF DRAWINGS

FIG. 1 is a longitudinal section showing the composition of a conventional antenna.

FIG. 2 is a longitudinal section showing the embodiment wherein the electromagnetic wave reducing device of the present invention is applied to the antenna of a mobile communication terminal provided with a whip antenna or helical antenna.

FIG. 3a and FIG. 3b are enlarged sections showing the extracts from the electromagnetic wave absorber used on the reducing device of the present invention.

FIG. 4 to FIG. 10 are drawings showing the first measure result under the state that the antenna of the present invention and a conventional antenna are installed at a CDMA mode mobile communication terminal and subsequently, a whip antenna portion is inserted,

FIG. 4 is a drawing showing a reflection loss graph.

FIG. 5 is a drawing showing a Smith Chart measuring impedance.

FIG. 6 is a drawing showing a standing-wave ratio graph.

FIG. 7 and FIG. 8 are drawings showing long-distant electromagnetic wave radial pattern from 824 MHz and 894 MHz.

FIG. 9 is a drawing showing short-distant electromagnetic wave radiated from a conventional antenna.

FIG. 10 is a drawing showing short-distant electromagnetic wave radiated from the antenna of the present invention.

FIGS. 11 to 17 are drawings showing the result of the second measure under the state that the antenna of the present invention and a conventional antenna are installed at the CDMA mode mobile communication terminal and a whip antenna is fetched.

FIG. 11 is a drawing showing a reflection loss graph,

FIG. 12 is a drawing showing the Smith chart measuring impedance,

FIG. 13 is a drawing showing a standing-wave ratio graph,

FIG. 14 and FIG. 15 are drawings showing long-distant electromagnetic radial pattern from 824 MHz and 894 MHz,

FIG. 16 is a drawing showing short-distant electromagnetic wave radiated from a conventional antenna.

FIG. 17 is a drawing showing short-distant electromagnetic wave radiated from the antenna of the present invention.

FIG. 18 to FIG. 23 are drawings showing the third measure result on the state that the antenna of the present invention and a conventional antenna are installed at a PCS mode mobile communication terminal, and a whip antenna is inserted,

FIG. 18 is a drawing showing a Smith chart measuring impedance,

FIG. 19 is a drawing showing a standing-wave ratio graph,

FIG. 20 is a drawing showing long-distant electromagnetic wave radiation pattern from 1.75 GHz, 1.78 GHz, 1.82 GHz and 1.87 GHz radiated from a conventional antenna.

FIG. 21 is a drawing showing long-distant electromagnetic wave radiation pattern from 1.75 GHz, 1.78 GHz, 1.84 GHz and 1.87 GHz radiated from the antenna of the present invention.

FIG. 22 is a drawing showing short-distant electromagnetic wave radiated from the antenna of a conventional antenna.

FIG. 23 is a drawing showing short-distant electromagnetic wave radiated from the antenna of the present invention.

FIG. 24 to FIG. 28 are drawings showing the fourth measure result on the state that the antenna of the present invention and a conventional antenna are installed at the PCS mode mobile communication terminal and a whip antenna is fetched.

FIG. 24 is a drawing showing the Smith chart measuring impedance,

FIG. 25 is a drawing showing a standing-wave ratio graph,

FIG. 26 is a drawing showing distant electron wave radiation pattern of 1.75 GHz, 1.78 GHz, 1.84 GHz and 1.87 GHz radiated from a conventional antenna,

FIG. 27 is a drawing showing long-distant electromagnetic wave radiation pattern of 1.75 GHz, 1.78 GHz, 1.84 GHz and 1.87 GHz radiated from the antenna of the present invention.

FIG. 28 is a drawing showing short-distant electromagnetic wave radiated from a conventional antenna,

FIG. 29 is a drawing showing short-distant electromagnetic wave radiated from the antenna of the present invention,

FIG. 30 is a longitudinal section showing another working examples applied to the antenna of a mobile communication terminal wherein the electromagnetic wave reducing device of the present invention is installed only at the whip antenna.

*Description of signs relating to the main portion of drawings*

| | | | |
|---|---|---|---|
| 100: | the helical antenna portion | 101: | metal road |
| 103: | helical antenna | 120: | whip antenna |
| 125: | wire | 300: | electromagnetic wave |
| | absorber | | |
| 302: | through bore | | |

### DETAILED DESCRIPTION OF THE INVENTION

### Purpose of the Invention

### The Field Pertaining to the Invention and Prior Art of the Field

The invention relates to the electromagnetic wave-reducing device of a mobile communication terminal which is installed at the mobile communication terminal, thereby reducing the intensity of short distance electromagnetic wave affecting human body from the antenna which transmits and receives high frequency of certain frequency.

Generally, wireless machinery is used on an antenna to carry out wireless communication. That is, wireless machinery applies the signal of high frequency which is output from the modulation portion, to an antenna, thereby transmitting it to the air and receiving the high frequency signals which are transmitted through the air.

In order to enhance the prosperities of transmittance and reception of the antenna, according to the frequency of high frequency signals to be transmitted and received, the impedances of the antenna and transceiver are matched to each other and unnecessary radiation is to be prevented and the loss should be reduced.

A helical antenna and a road antenna are structurally and integrally in the antenna used on portable wireless machinery.

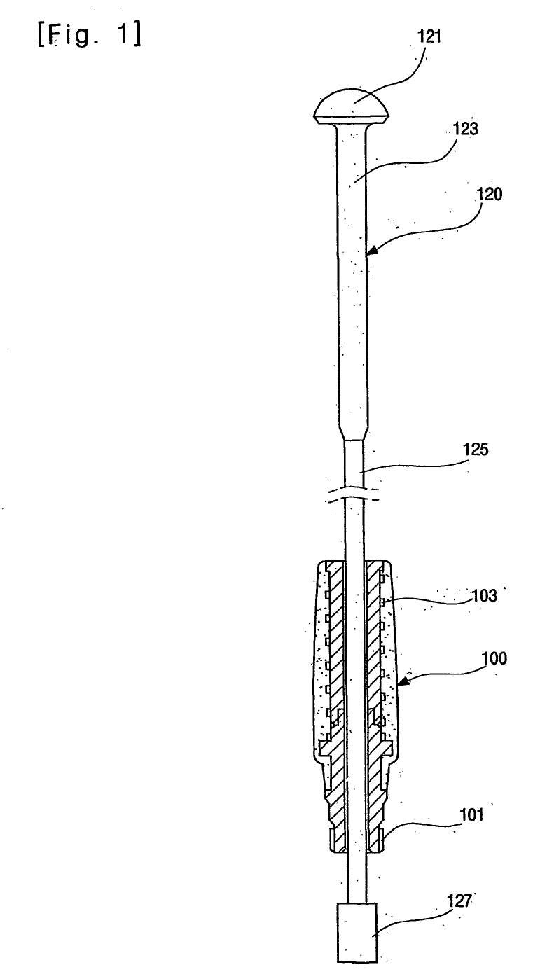

FIG. 1 is a longitudinal section showing the composition of a conventional antenna. As illustrated, the antenna used on a mobile communication terminal consists of a helical antenna portion (100) and a whip antenna portion (120).

Said helical antenna portion (100) wherein a helical antenna (103) winding a wire, is fixed on the upper portion of a metal road (101), and the metal road (101) and the helical antenna (103) leave the lower portion of the metal road (101) to be fixed at the mobile communication terminal, and are molded by inserting and injecting it.

If we review said whip antenna portion (120), a handle portion (121) which the user may grasp in case of where the whip antenna portion (120) is expanded and/or received, an insulation portion (123), and a fixed length of wire (125) are in a row, thereby penetrating the center of said helical antenna portion (100), and a stopper (127) is fixed to the lower portion of the wire (125) in order for the whip antenna (120) from being detachable from the helical antenna portion (100).

An antenna having the same composition as mentioned above, is commonly fixed to a mobile communication terminal. A metal road (11) is electrically connected to the transceiver portion provided with the mobile communication terminal, thereby transmitting and receiving the high frequency signals of frequency. Where the whip antenna portion (120) is inserted, the helical antenna (103) of the helical antenna portion (100) operates, thereby transmitting and receiving high frequency signals. In a case where the whip antenna portion (120) is expanded, the whip antenna portion (120) and the helical antenna are parallel combined with each other, thereby being operated.

As a general rule, a mobile communication terminal generates a lot of electromagnetic wave at the time of telephone communication. According to the research results, it has revealed that said electromagnetic wave generated, particularly short-distant electromagnetic wave causes the failure of memory and excitement, thereby being harmful to human body. Accordingly, many countries including the U.S., Japan, European countries, etc. . . . regulates the strength of short-distant electromagnetic wave radiated from a mobile communication terminal.

Therefore, various countries are making much efforts to reduce the strength of short-distant electromagnetic wave radiated from an antenna. However, the antenna of a mobile communication terminal still generates much short-distant electromagnetic wave.

### Technical Problem Intended to be Resolved by the Present Invention

Accordingly, the purpose of the present invention is to provide the electromagnetic wave-reducing device of a mobile communication terminal allowing short-distant electromagnetic wave to effectively be reduced without almost affecting long-distant electromagnetic wave generating from the antenna of a mobile communication terminal at the time of telephone communication.

### The Composition and Effect of the Present Invention

The purpose of the electromagnetic wave reducing device of a mobile communication terminal is not to almost affect long-distant electromagnetic wave radiated from a mobile communication terminal and to effect reduce short-distant electromagnetic wave only, and electromagnetic wave absorber is built in the antenna to effectively reduce short-distant electromagnetic wave only. The electromagnetic wave absorber is provided with the exterior of the metal road of said helical antenna. In this context, it is desirable that said electromagnetic absorber is installed at the exterior of the lower portion of the location which the helical antenna connects, of the metal road.

The upper portion of said electromagnetic wave absorber is formed as a cylinder having a big diameter and the lower portion is formed as a cylinder having a small diameter and a through bore is formed at the central portion. Accordingly, said metal road is inserted at the through bore or the said is formed as a cylinder in entirety, and the through bore is formed at the central portion, therefore, said helical antenna is inserted at the through bore or is integrally inserted and injected at the metal road.

In addition, said electromagnetic absorber consists of magnese zinc ferry magnetic material including Y₂O₃ 1.8˜2.0 weight %, K₂O 0.04˜0.09 weight %, TiO₂ 0.02˜0.09 weight %, Na₂O 0.29˜0.38 weight %, MnO₂ 14.0˜15.0 weight %, ZnO 15.0˜16.5 weight %, Fe₂O₃ 65.0˜75.0 weight %, CaO 0.05˜0.09 weight %, SiO₂ 0.60˜0.85 weight %, NiO 0.01˜0.03 weight % and Cr₂O₃ 0.01˜0.05 weight %.

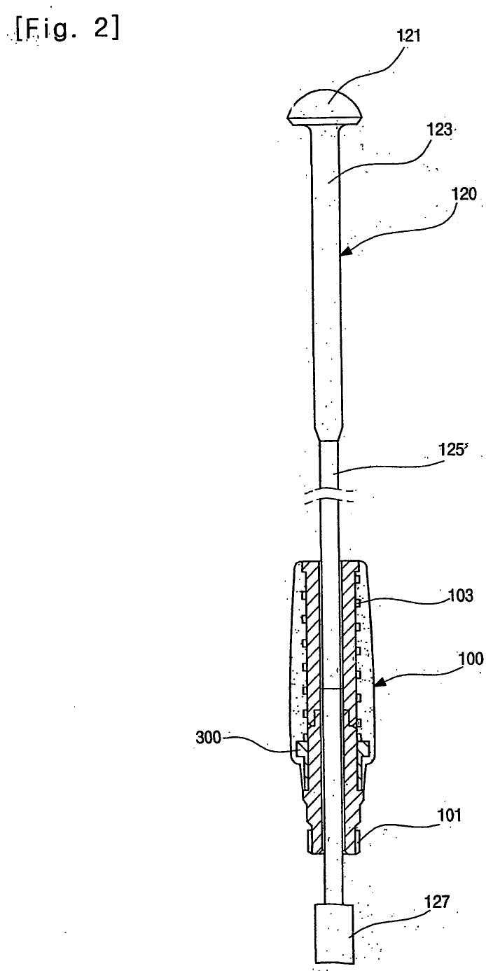

The description of the electromagnetic wave-reducing device of the mobile communication terminal of the present invention, will in detail be provided, referring to drawings of FIGS. 2 to 10 attached hereinafter. In this context, the same signals as prior those are assigned.

FIG. 2 is a longitudinal section illustrating the antenna of a mobile communication terminal according to the electromagnetic wave reducing device of the present invention. As illustrated above, the present invention refers to the fact that an electromagnetic wave absorber (300) is provided at the exterior of the metal road (101) which is in said helical antenna portion (100) in the antenna of a mobile communication terminal consisting of a helical antenna (100) and a whip antenna (120).

Said electromagnetic wave absorber (300) comprises magnese zinc ferry magnetic material including Y₂O₃ 1.8˜2.0 weight %, K₂O 0.04˜0.09 weight %, TiO₂ 0.02˜0.09 weight %, Na₂O 0.29˜0.38 weight %, MnO₂ 14.0˜15.0 weight %, ZnO 15.0˜16.5 weight %, Fe₂O₃ 65.0˜75.0 weight %, CaO 0.05˜0.09 weight %, SiO₂ 0.60 ˜0.85 weight %, NiO 0.01˜0.03 weight % and Cr₂O₃ 0.01˜0.05 weight %.

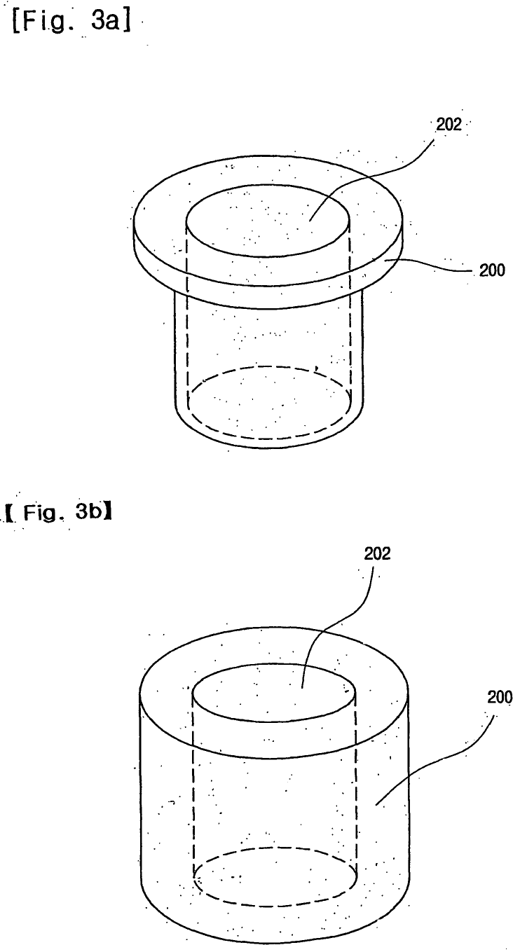

For example, as illustrated in FIG. 3A, said electromagnetic wave absorber (300) is in its entirety formed as a cylinder, and a through bore (303) is formed at the central portion, thereby said metal road (101) being inserted at the through bore (302). In this context, it is desirable that an electromagnetic wave absorber is installed at the exterior antenna (103) is fixed at the metal road (101). As illustrated in FIG. 3b, the upper portion of said electromagnetic wave absorber (300), is formed as a cylinder having a big diameter, and the lower portion having a small diameter, is formed. At the same time, at the central portion, a through bore (302) is formed, thereby said metal road (1010) can be inserted at the through bore (302).

The addition, in the present invention, said electromagnetic wave absorber (300) is not manufactured independently, and the manufactured metal road (101) is inserted at the fixed metal mould, and then an electromagnetic wave absorber (300) may integrally be inserted and injected.

The antenna of the present invention composed in such manner, is installed at a mobile communication terminal in a common way, and the metal road (11) is electrically connected to the transceiver provided within the mobile communication terminal. Therefore, the antenna receives and transmits the high frequency signals of certain frequency.

On the state that the antenna of the present invention had a conventional antenna are fixed to a CDMA mode mobile communication terminal and a PCS mode mobile communication terminal respectively and the whip antenna portion (120) is inserted and pulled out, the property is measured.

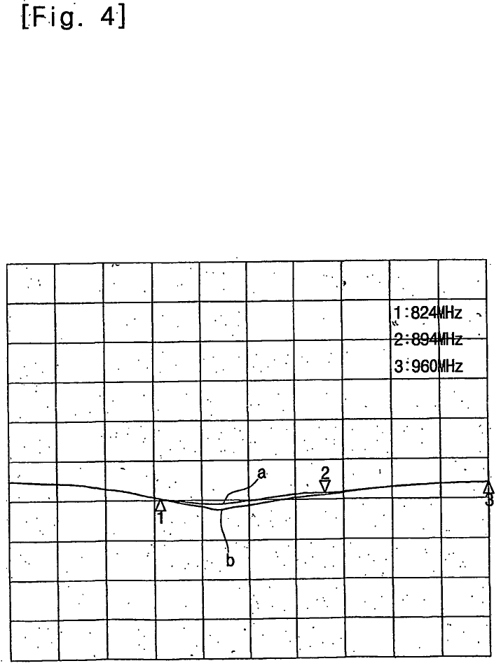

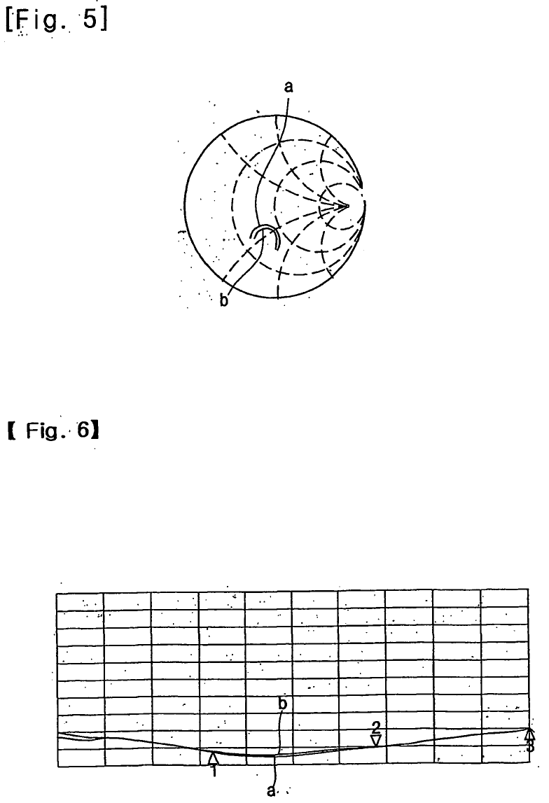

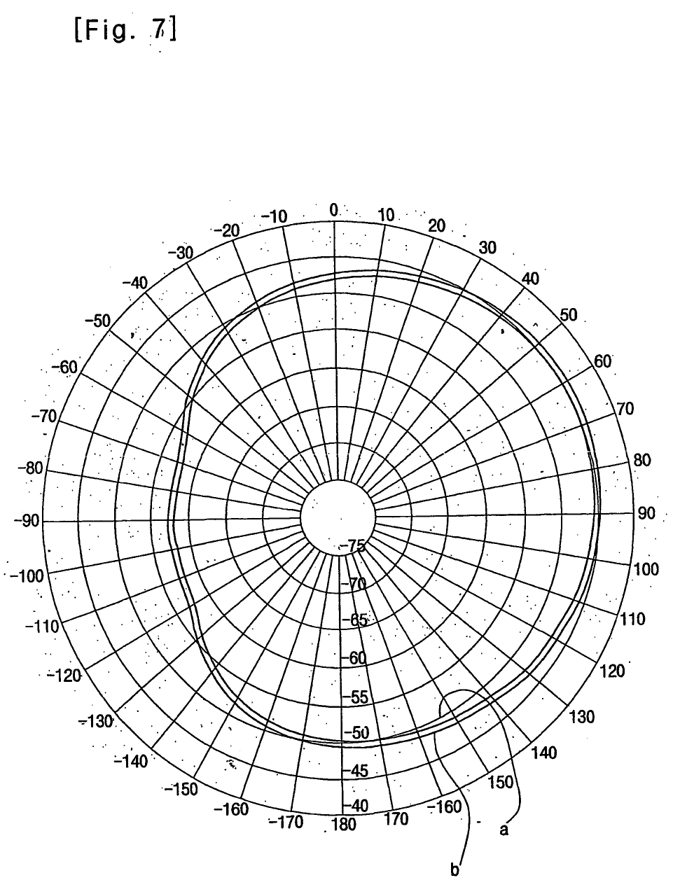

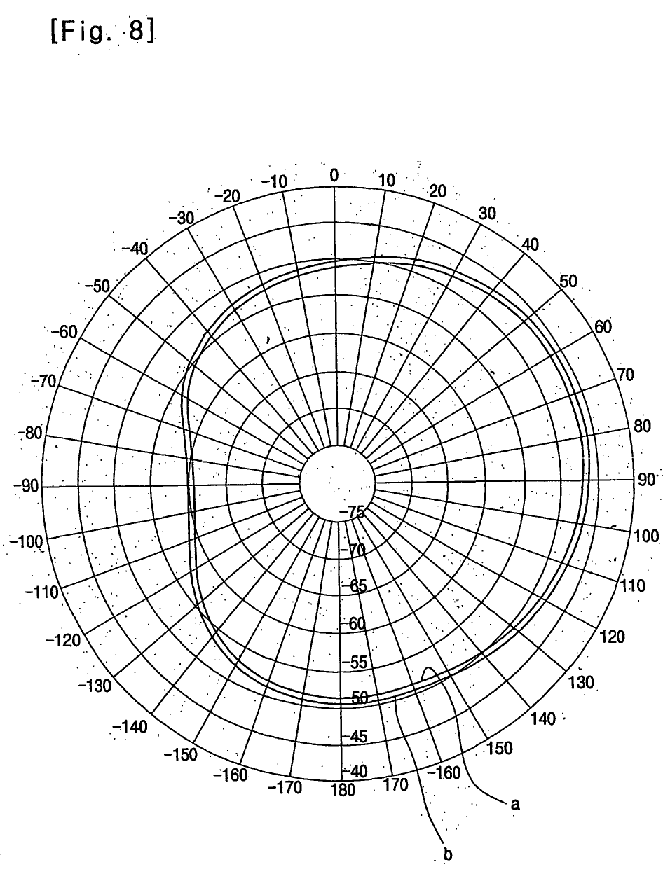

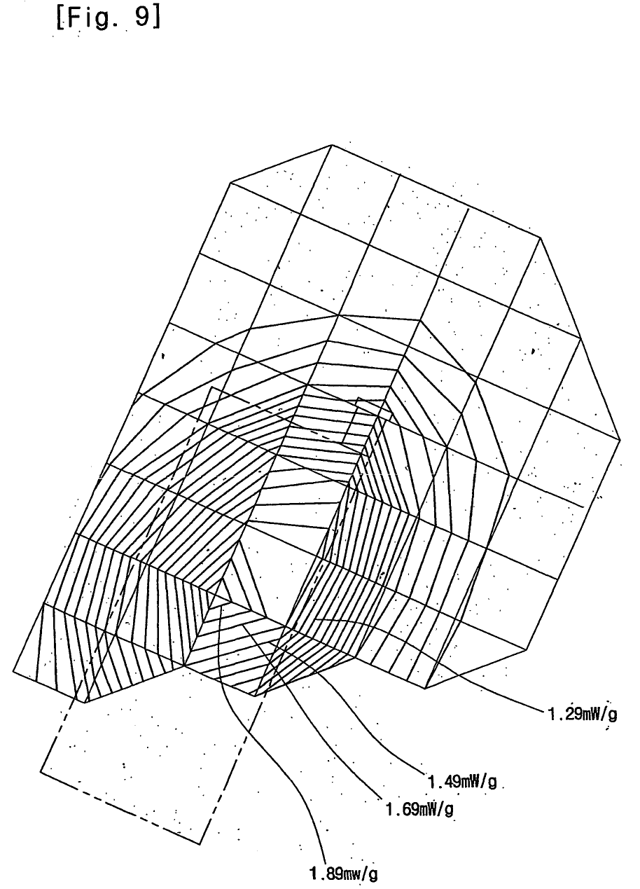

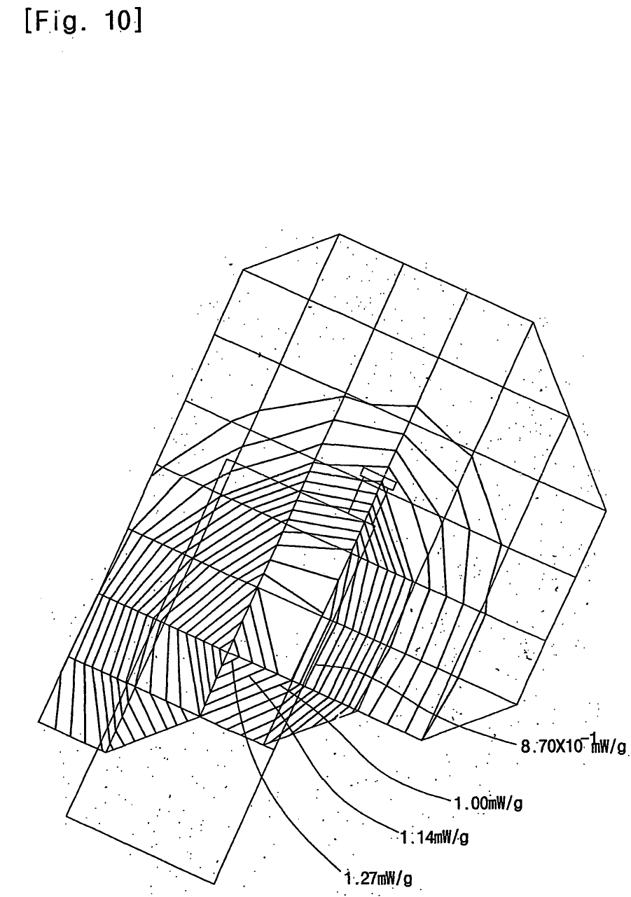

FIGS. 4 to 10 are drawing illustrating the first measure results which are measured on the state that the antenna of the present invention and prior antenna are installed at the CDMA mode mobile communication terminal and the whip antenna is inserted. FIG. 4 is a drawing illustrating the reflection loss graph. FIG. 5 is a drawing illustrating the Smith chart measuring impedance and FIG. 6 is a drawing illustrating the standing-wave ratio graph and FIG. 7 and FIG. 8 are drawing illustrating the long-distant electromagnetic wave radiation pattern from 824 MHz and 894 MHz. FIG. 9 is a drawing illustrating short-distant electromagnetic wave radiated from prior antenna and FIG. 10 is a drawing illustrating short-distant electromagnetic wave radiated from the antenna of the present invention.

In this context, the positions (1˜3) of each point (Δ and/or ∇) show the measure frequency position of 824 MHz, 894 MHz and 960 MHz respectively, and a is the measure value of the antenna of the present invention and b is the measure value of the conventional antenna.

According to said first measure results, it has been revealed that the reflection loss, impedance and standing-wave ratio remain almost unchanged, as illustrated in FIGS. 4 to 6, on the state that the antenna of the present invention and prior antenna are installed at a CDMA mode mobile communication terminal and the whip antenna portion is inserted. Also, it has been revealed that long-distant electromagnetic wave radiation pattern is −44.35 dB at the azimuth angle of 67°, in 824 MHz and in case of the antenna of the present invention, it is −44.99 dB at the azimuth angle of 68°, shown in FIG. 7. As shown in FIG. 8, in case of the conventional antenna, it is −46.18 dB in 894 MHz at the azimuth angle of 68° and in a case of the antenna of the present invention, it is −46.72 dB at the azimuth angle of 72°.

However, the maximum value of short-distant electromagnetic wave radiated from the mobile communication terminal having the prior antenna, as shown in FIG. 9, is 1.89 mW/g, whereas that of short-distant electron wave radiated from the mobile communication terminal having the antenna of the present invention is 1.27 mW/g, as shown in FIG. 10. That is, the maximum value has been remarkably reduced.

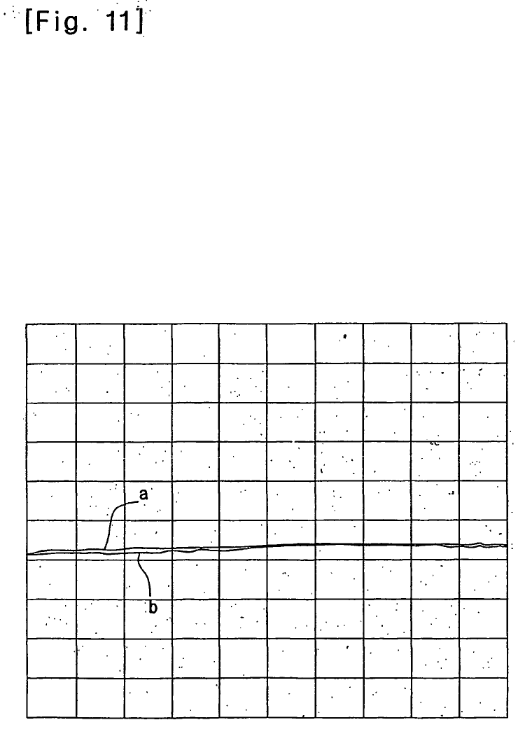

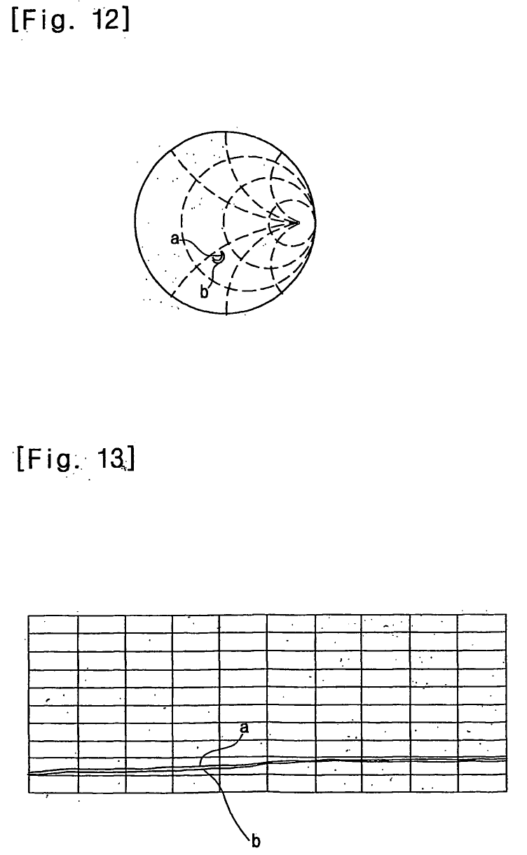

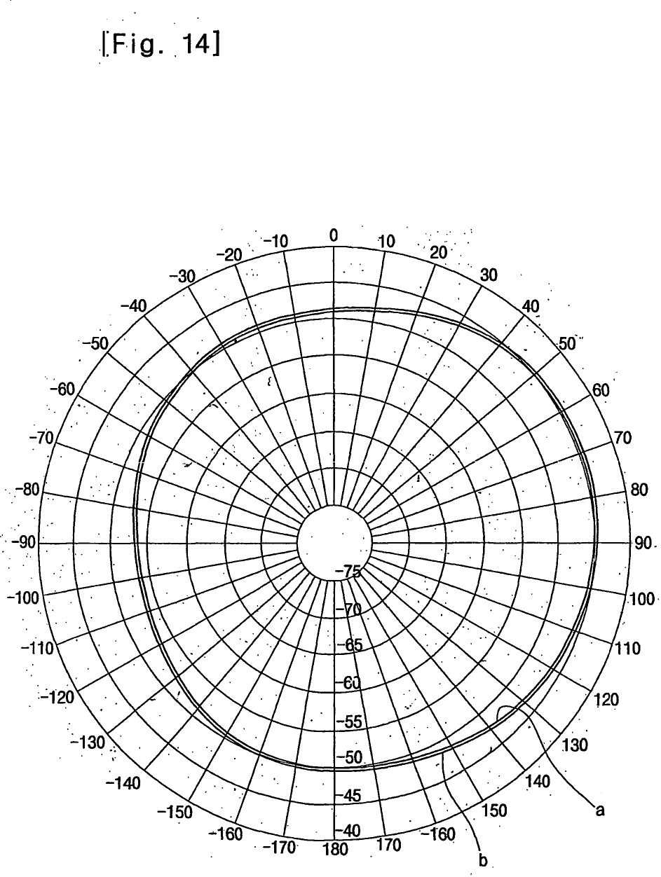

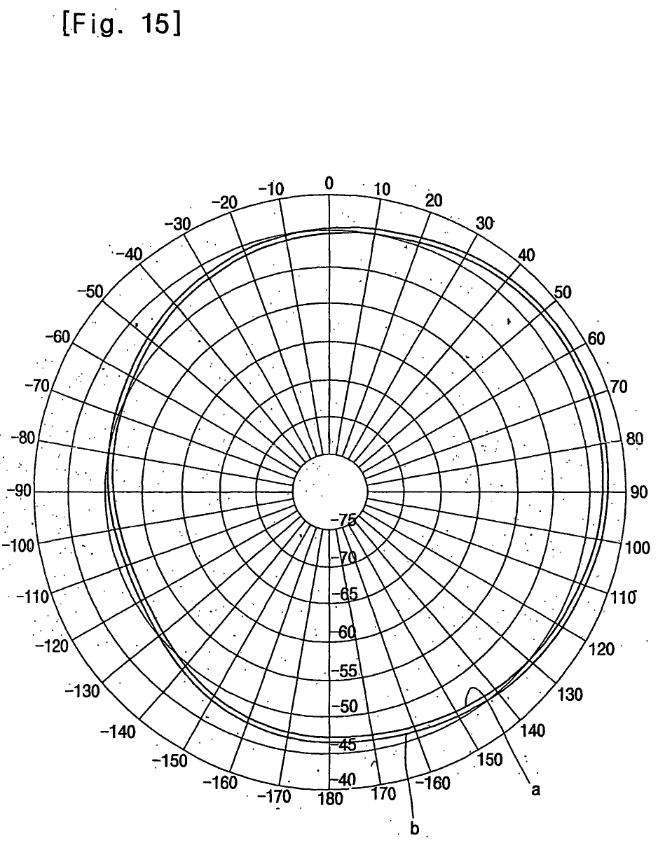

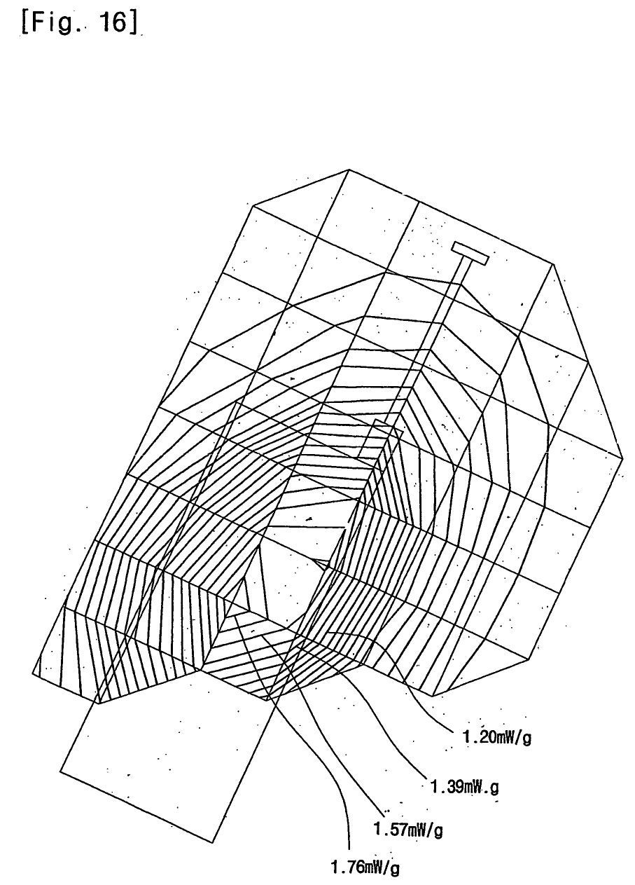

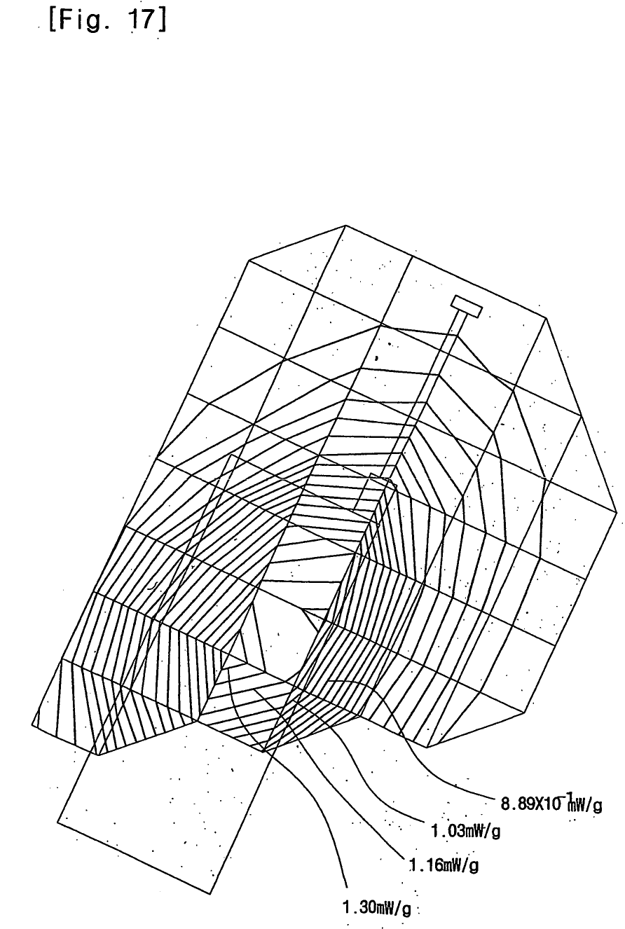

FIGS. 11 to 17 are drawings showing that the second measure results on the state that the antenna of the present and prior antenna were installed at the CDMA mode mobile communication terminal and the whip antenna were pulled out. FIG. 11 is a drawing showing the reflection loss graph and FIG. 12 is a drawing showing the Smith chart measuring impedance and FIG. 13 is a drawing showing the standing-wave ratio graph. FIGS. 14 and 15 are drawings showing the long-distant electromagnetic wave radiation pattern from 824 MHz and 894 MHz. FIG. 16 is a drawing showing the short-distant electromagnetic wave radiated from prior antenna and FIG. 17 is a drawing illustrating the short-distant electromagnetic wave radiated from the antenna of the present invention.

In this context, the positions (1˜3) of each point (Δ and/or ∇) refer to the measure frequency positions of 824 MHz, 894 MHz and 960 MHz respectively. a is the measure value of the antenna of the present invention and b is the measure value of the prior antenna.

Even, in the second 2 measure results, the reflection loss, impedance and the standing-wave ratio remain unchanged on the state that the antenna of the present invention and prior antenna are built in the CDMA mode mobile communication terminal and the whip antenna portion is pulled out, as shown in FIGS. 11 to 13.

Also, as shown in FIG. 14, in the case of the prior antenna, the long-distant electromagnetic radiation pattern is −42.30 dB in 824 MHz at the azimuth angle of 71° and in the case of the antenna of the present invention, it is −42.87 dB at the azimuth angle of 73° and as shown in FIG. 15, in the case of the prior antenna, it is −44.43 dB in 894 MHz at the azimuth angle of 77° and in the case of the antenna of the present invention, it is −45.03 dB at the azimuth angle of 73°. In light of the above results, the long-distant electromagnetic radiation pattern remains unchanged.

However, the maximum value of short-distant electromagnetic wave radiated from the mobile communication terminal having the prior antenna, as shown in FIG. 16, is 1.75 mW/g whereas that of short-distant electromagnetic wave radiated from the mobile communication terminal having the antenna of the present invention is 1.30 mW/g. The maximum value has remarkably been reduced.

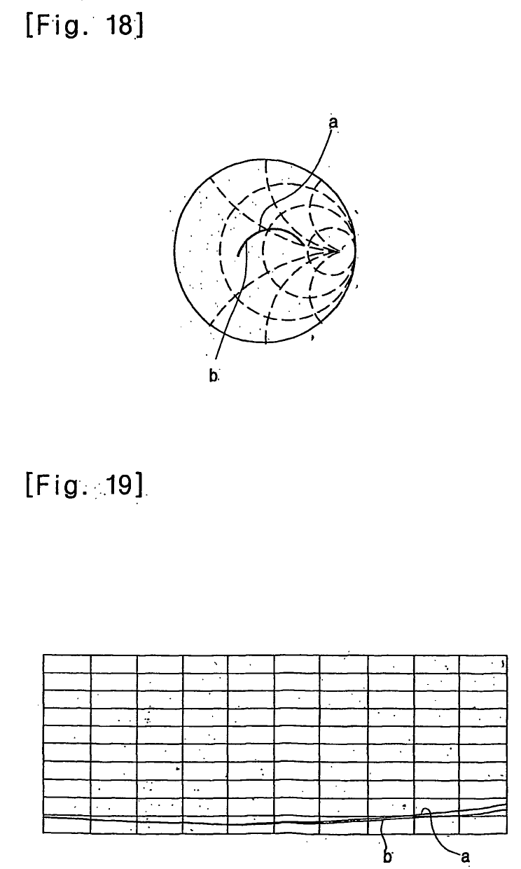

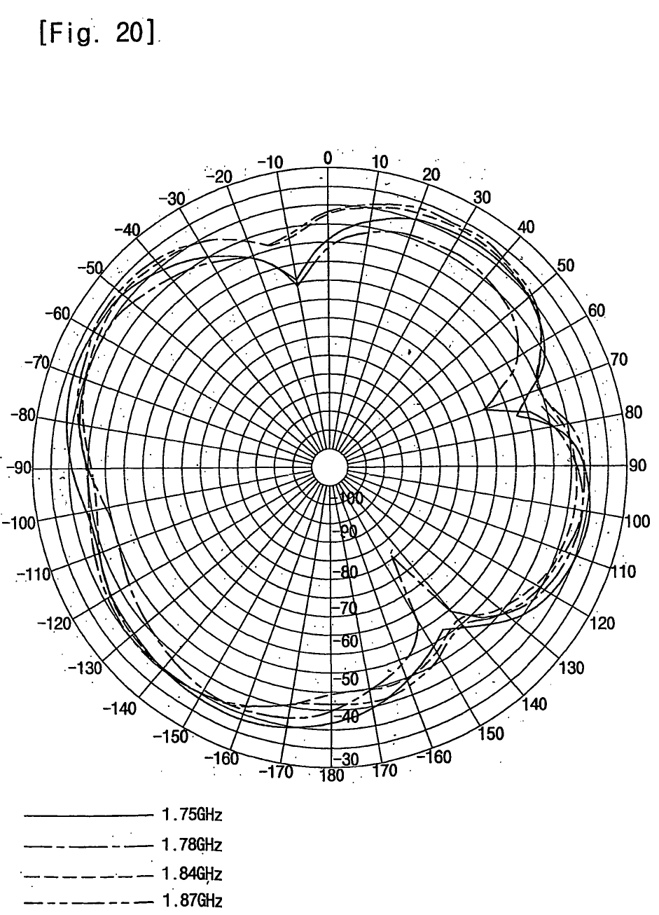

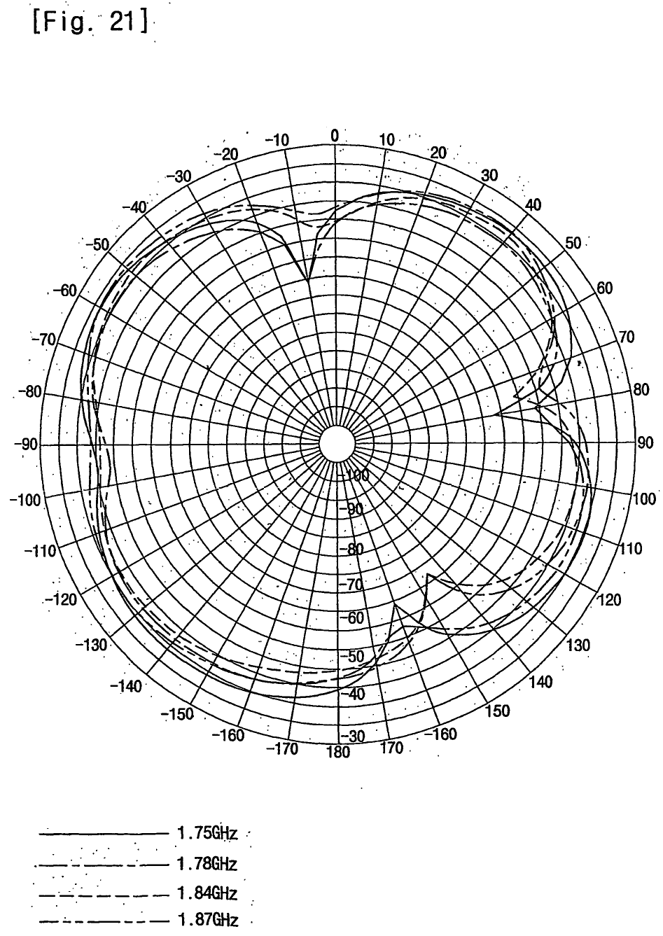

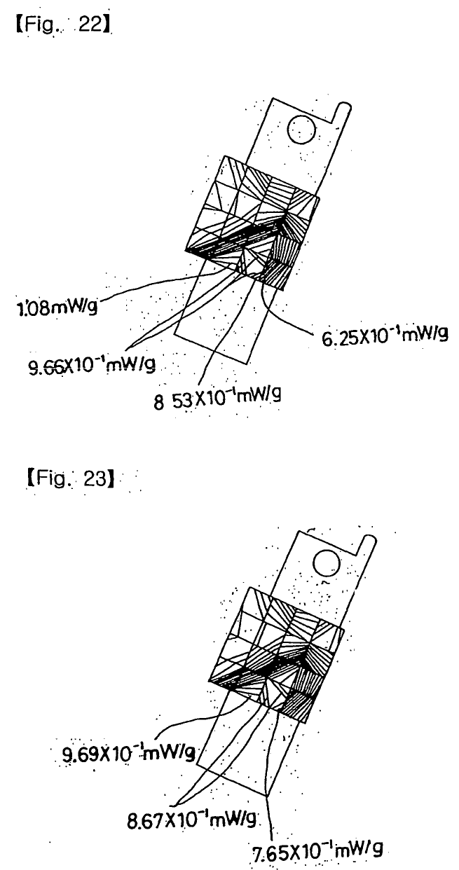

FIG. 18 to FIG. 23 are drawings illustrating the third measure results on the state that the antenna of the present invention and prior antenna are installed at the PCS mode mobile communication terminal and the whip antenna portion is inserted. FIG. 18 is a drawing showing the Smith chart measuring impedance and FIG. 19 is a drawing showing the standing-wave ratio graph, FIG. 20 is a drawing showing electromagnetic radiation pattern from 1.75 GHz, 1.78 GHz, 1.84 GHz radiated from the conventional antenna, FIG. 21 is a drawing illustrating long-distant electromagnetic radiation pattern from 1.75 GHz, 1.78 GHz, 1.84 GHz and 1.87 GHz radiated from the antenna of the present invention. FIG. 22 is a drawing illustrating short-distant electromagnetic wave radiated from the antenna of the present invention. FIG. 23 is a drawing showing short-distant electromagnetic wave radiated from the antenna of the present invention.

In this context, the positions (11˜14) of each point (Δ and/or ∇) stand for the measure frequency positions of 1.75 GHz, 1.78 GHz, 1.84 GHz and 1.87 GHz respectively, and a is the measure value of the present invention and b is the measure value of the conventional antenna.

Also according to the third measure result, on the state that the antenna of the present invention and the conventional antenna are installed at the PCS mode mobile communication terminal and the whip antenna is inserted, the impedance and the standing-wave ratio remain unchanged as in FIG. 18 and FIG. 19. As illustrated in FIG. 20, the maximum value of long-distant electromagnetic wave radiation pattern of the prior antenna is −37.76 dB at the azimuth angle of −65° in 1.75 GHz, −40.09 dB at the azimuth angle of −65° in 1.78 GHz, −37.44 dB at the azimuth angle of 30° in 1.84 GHz and −36.40 dB at the azimuth angle of 30° in 1.87 GHz. Whereas in case of the antenna of the present invention, as illustrated in FIG. 21, the maximum value of long-distant radiation pattern is −36.94 dB in 1.75 GHz at the azimuth angle of 45°, −40.02 dB in 1.78 GHz at the azimuth angle of −55°, −38.08 dB in 1.84 GHz at the azimuth angle of −45°, −36.46 dB in 1.87 GHz at the azimuth angle of −50°. From these results, we can see that the maximum values remain unchanged. However, the maximum value of short-distant electromagnetic wave radiated from a mobile communication terminal in which the conventional antenna is built, is 1.67 mW/g, as shown in FIG. 22 while the maximum value of short-distant electromagnetic wave radiated from a mobile communication terminal in which an antenna of the present invention is built, is 1.51 mW/g. From the results, we can see that the maximum values has been remarkably reduced.

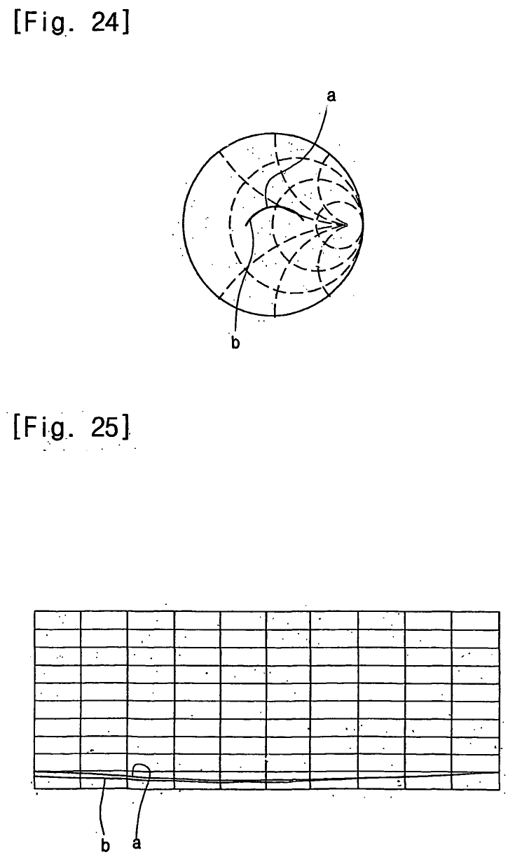

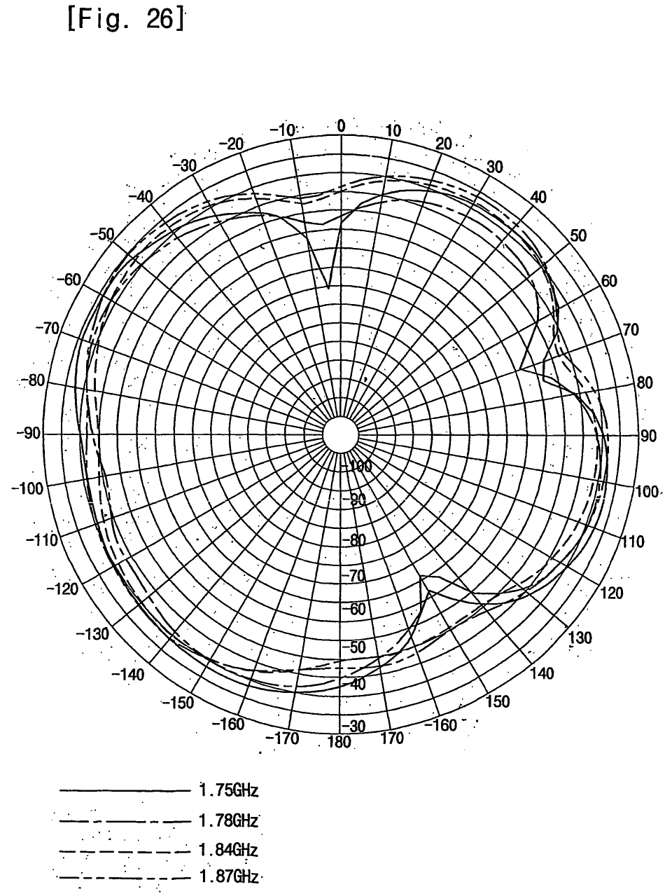

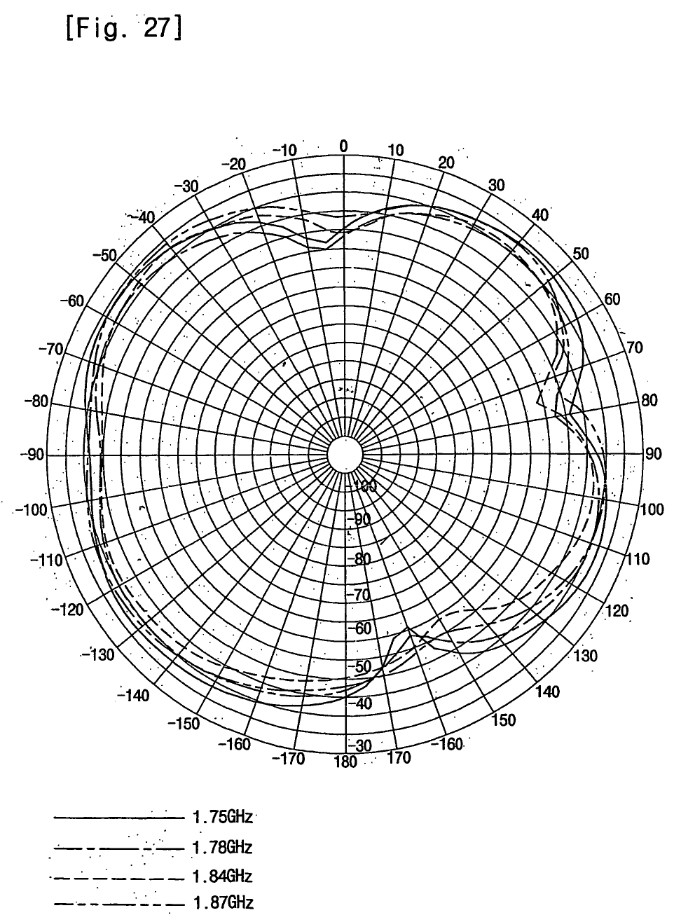

FIGS. 24 to 29 are drawings showing the fourth measure results on the state that the antenna of the present invention and the conventional antenna are installed at the PCS mode mobile communication terminal and the whip antenna is pulled out. FIG. 24 is a drawing showing the Smith chart measuring impedance and FIG. 25 is a drawing illustrating the standing-wave ratio graph, FIG. 26 is a drawing showing long-distant electromagnetic radiation pattern of 1.75 GHz, 1.78 GHz, 1.84 GHz and 1.87 GHz radiated from the prior antenna. FIG. 27 is long-distant electromagnetic radiation pattern of 1.75 GHz, 1.78 GHz, 1.84 GHz and 1.87 GHZ radiated from the antenna of the present invention.

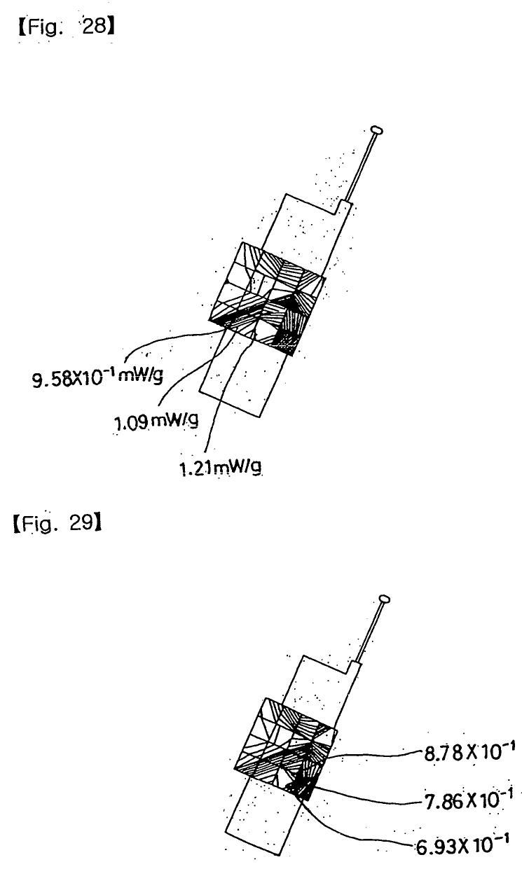

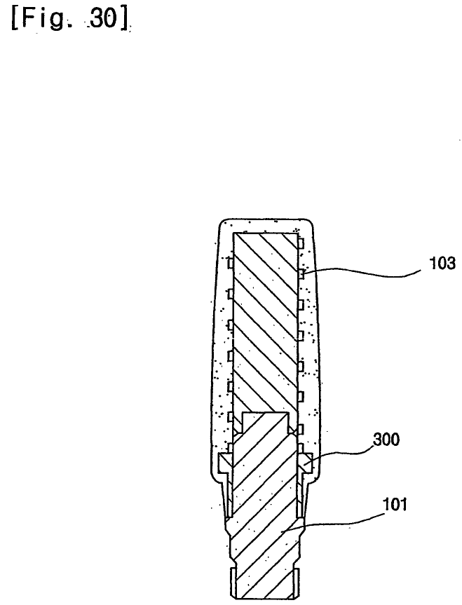

FIG. 28 is a drawing illustrating long-distant electromagnetic radiation pattern radiated from the conventional antenna and FIG. 29 is a drawing showing short-distant electromagnetic wave radiated from the antenna of the present invention.

In this context, the positions (11˜14) of each point (Δ and/or ∇) stand for the measure frequency position of 1.75 GHz, 1.78 GHz, 1.84 GHz and 1.87 GHz respectively, and a is the measure value of the antenna of the present invention and be is the measure value of the conventional antenna.

Also, according to the fourth measure results, it has been revealed that the impedance and the standing-wave ratio of the state that the antenna of the present invention and prior antenna are installed at the PCS mode mobile communication terminal and the whip antenna is pulled out, remain unchanged as in FIGS. 24 and 25. Also, as illustrated in FIG. 26, the value of long-distant electromagnetic radiation pattern is −36.06 dB at 1.75 GHz and the azimuth angle of −60°, −38.82 dB in 1.84 GHz at the azimuth angle of +60, −37.48 dB at 1.84 GHz at the azimuth angle of −45°, −35.53 dB in 1.87 GHz and the azimuth angle of −50°. Whereas in case of the antenna of the present invention, as illustrated in FIG. 27, it is −36.19 dB in 1.75 GHz at the azimuth angle of −55°, −38.80 dB in 1.78 GHz at the azimuth angle of −55°, −37.48 dB at 1.84 GHz at the azimuth angle of −45°. Eventually, the maximum value remains unchanged.

However, the maximum value of short-distant electromagnetic wave radiated from the mobile communication terminal wherein the prior antenna is installed, as FIG. 28, is 1.32 mW/g. While the maximum value of short-distant electromagnetic wave radiated from the mobile communication terminal, wherein the antenna of the present invention is installed, is 0.92 mW/g. That is, the maximum value has been remarkably reduced.

FIG. 30 is a longitude section showing another working example applied to the antenna of the mobile communication terminal wherein only the whip antenna is installed as the electromagnetic wave reducing device of the present.

As illustrated, the present invention is that in the antenna of the mobile communication terminal wherein the helical antenna (103) is fixed, inserted and injected and molded at the upper portion of the metal road (101), the electromagnetic wave absorber (300) is installed at the exterior of said metal road (101), as in said working example.

The properties are measured on the stat that the antenna of working example of the present invention and the prior antenna are fixed at the CDMA mode and PCS mode mobile communication terminal respectively.

According to the measure results, it has been revealed that prosperities similar to the first and third measure results, namely, reflection loss, impedance, standing-wave ratio and long-distant electromagnetic wave radiation pattern remain unchanged, but short-distant electromagnetic wave radiation pattern which affect human body, has remarkably been reduced.

As described thus far, the present invention was explained, together with the illustration of the specific preferred embodiment. It will be appreciated that it is not intended to limit the present invention to the above example only, many variations, such as might readily occur to one skilled in the art, being possible, without departing from the scope thereof.

### Effect of the Invention

According to the present invention described thus far, the present invention reduces the strength of short-distant electromagnetic wave radiated from the mobile communication terminal by inserting the electromagnetic wave absorber at the metal road of the antenna. And it does not almost affect the radiation of long-distant electromagnetic wave radiation as well as the reflection loss of the antenna, impedance and standing-wave ratio and can reduce the affect on the human body due to short-distant electromagnetic wave by effectively reducing the strength of short-distant electromagnetic wave.

1. In an antenna of a mobile communication terminal comprising a helical antenna portion wherein a helical antenna wherein a wire is wound, is fixed at the upper portion of the metal road, therefore, are molded and a whip antenna portion which has a wire of fixed length and which is installed through and the center of said helical antenna portion, thereby being inserted and pulled,
an electromagnetic wave-reducing device wherein an electromagnetic wave absorber is at the exterior of the metal road of the said helical antenna.

2. Said electromagnetic absorber as set forth in claim 1;
An electromagnetic-reducing device of a mobile communication terminal wherein the upper portion is formed as a cylinder having a big diameter and the lower portion is formed as a cylinder having small diameter, and a through bore is formed at the central portion, thereby said metal road is inserted at the through bore.

3. Said electromagnetic absorber as set forth in claim 1;
An electromagnetic-reducing device of a mobile communication terminal wherein it is formed as a cylinder, and a through bore is formed at the central portion, thereby said metal road being inserted at the through bore.

4. Said electromagnetic absorber as set forth in claim 1;
An electromagnetic wave-reducing device of a mobile communication terminal wherein they are in integrally inserted to each other.

5. Said electromagnetic absorber as set forth in any one of claims 1 to 4;
An electromagnetic-reducing device of a mobile communication terminal wherein said electromagnetic absorber comprises magnese zinc ferry magnetic material including Y₂O₃ 1.8˜2.0 weight %, K₂O 0.04˜0.09 weight %, TiO₂ 0.02˜0.09 weight %, Na₂O 0.29˜0.38 weight %, MnO₂ 14.0˜15.0 weight %, ZnO 15.0˜16.5 weight %, Fe₂O₃ 65.0˜75.0 weight %, CaO 0.05˜0.09 weight %, SiO₂ 0.60˜0.85 weight %, NiO 0.01˜0.03 weight % and Cr₂O₃ 0.01˜0.05 weight %.

6. In an antenna of a mobile communication terminal wherein a helical antenna wherein a wire is wound, is fixed at the upper portion of the metal road, and then leaves the lower portion of the metal road fixed to the mobile communication terminal, and the upper portion is molded,
An electromagnetic-reducing device of a mobile communication terminal wherein an electromagnetic wave absorber is installed at the exterior of said metal road.

7. Said electromagnetic absorber as set forth in claim 6;
an electromagnetic wave-reducing device of a mobile communication terminal wherein the upper portion is formed as a cylinder having big diameter and lower portion is formed as a cylinder having a small diameter and a through bore is formed at the central portion, thereby said metal road being inserted at the through bore.

8. Said electromagnetic absorber as set forth in claim 6;
an electromagnetic wave-reducing device of a mobile communication terminal wherein they are formed as cylinders and a through bore is formed at the central portion, thereby said metal road being inserted at the through bore.

9. Said electromagnetic absorber as set forth in claim 6;
an electromagnetic wave-reducing device of a mobile communication terminal which is inserted and injected at the metal road.

10. Said electromagnetic absorber as set forth in claims 6 to 9;
an electromagnetic wave-reducing device of a mobile communication terminal comprising magnese zinc ferry magnetic material including Y₂O₃ 1.8˜2.0 weight %, K₂O 0.04˜0.09 weight %, TiO₂ 0.02˜0.09 weight %, Na₂O 0.29˜0.38 weight %, MnO₂ 14.0˜15.0 weight %, ZnO 15.0˜16.5 weight %, Fe₂O₃ 65.0˜75.0 weight %, CaO 0.05˜0.09 weight %, SiO₂ 0.60˜0.85 weight %, NiO 0.01˜0.03 weight % and Cr₂O₃ 0.01˜0.05 weight %.
